(19) United States
(12) Patent Application Publication
(10) Pub. No.: US 2006/0150946 A1
(43) Pub. Date: Jul. 13, 2006

(54) Rotary piston engine

(76) Inventor: H. D. Rusty Wright, Dallas, TX (US)

Correspondence Address: JACKSON WALKER LLP, 901 MAIN STREET, SUITE 6000, DALLAS, TX, 75202-3797, US

(21) Appl. No.: 11/329,637

(22) Filed: Jan. 11, 2006

Related U.S. Application Data
(60) Provisional application No. 60/643,031, filed on Jan. 11, 2005.

(51) Int. Cl. F02B 53/04

(52) U.S. Cl. 123/231; 123/232; 123/238

(57) ABSTRACT

A rotary piston engine having a main rotor, a power rotor, and an exhaust rotor which is capable of carrying out intake, compression, combustion, and exhaust simultaneously.

### CLAIM OF PRIORITY

The present invention claims priority of U.S. Provisional patent application Ser. No. 60/643,031 filed Jan. 11, 2005 entitled Rotary Piston Engine.

### FIELD OF THE INVENTION

The present invention is generally related to engines, and more particularly to rotary piston engines.

### BACKGROUND OF THE INVENTION

Internal combustion engines are well known in the art and are used to operate a wide variety of motorized vehicles and equipment. These internal combustion engines utilize the same basic principle, namely, the rapid expansion and energy release that is accompanied by the ignition of particular fuels.

One typical internal combustion engine, found in many automobiles, utilizes a four stroke combustion cycle. The four strokes in the cycle are the intake stroke, the compression stroke, the combustion stroke, and the exhaust stroke. A reciprocating internal combustion engine undergoes each stroke of the cycle in succession, utilizing the same cylinder and piston. It typically takes a reciprocating engine two full revolutions, or 720 degrees, to complete the four strokes in the combustion cycle.

By contrast, a rotary piston engine works according to a different mechanism. In a rotary piston engine, all four strokes of the combustion cycle take place simultaneously in different parts of the engine housing. A rotor within the housing rotates to make contact with alternating parts of the housing interior, creating separate volumes of gas in different chambers. As the rotor moves, each volume of gas expands and contracts to draw fuel into the engine and expel exhaust. The rotor and the housing are designed so that the desired portions of the rotor never lose contact with the interior of the housing, and the separate chambers of gas remain sealed off.

There is desired an improved rotary piston engine that utilizes true rotary power in an efficient and constant fashion.

### SUMMARY OF INVENTION

The present invention achieves technical advantages as a rotary piston engine that carries out all four strokes of the combustion cycle simultaneously, utilizing fewer moving components and is considerably more cost-effective to manufacture than other engines.

In one embodiment of the invention, the rotary piston engine comprises only three moving components: a main rotor, a power rotor, and an exhaust rotor. The rotors are designed in such a way that they remain in contact with each other and the engine housing throughout the entire cycle. Although each rotor is generally circular in shape, the power rotor and the exhaust rotor have partial concave indentions which fit rounded rotary piston projections that extend from the outer diameter of the main rotor. As the rotors rotate, they engage each other at different points and create a progressive series of chambers at different areas of the housing. Each chamber performs a different stroke of the combustion cycle simultaneously.

### BRIEF DESCRIPTION OF THE DRAWINGS

FIG. 1 is a top view of one embodiment of the rotary piston engine.

FIG. 2 is a breakaway view of the rotary piston engine having a separate set of gears and a cover.

FIG. 3 shows a series of top views of the rotary piston engine as it undergoes the four strokes of the cycle simultaneously.

FIG. 4 is an enlarged view of the main rotor.

FIG. 5 is an enlarged view of the power rotor.

FIG. 6 is an enlarged view of the exhaust rotor.

FIG. 7 is a top view of the rotary piston engine having two exhaust rotors.

FIG. 8 is a perspective view of the rotary piston engine in which the rotors are also gears.

FIG. 9 shows a series of side views of a reciprocating engine (Views 1-8) and top views of the rotary piston engine (Views 1a-4a) as a comparison.

### DETAILED DESCRIPTION OF THE PRESENT INVENTION

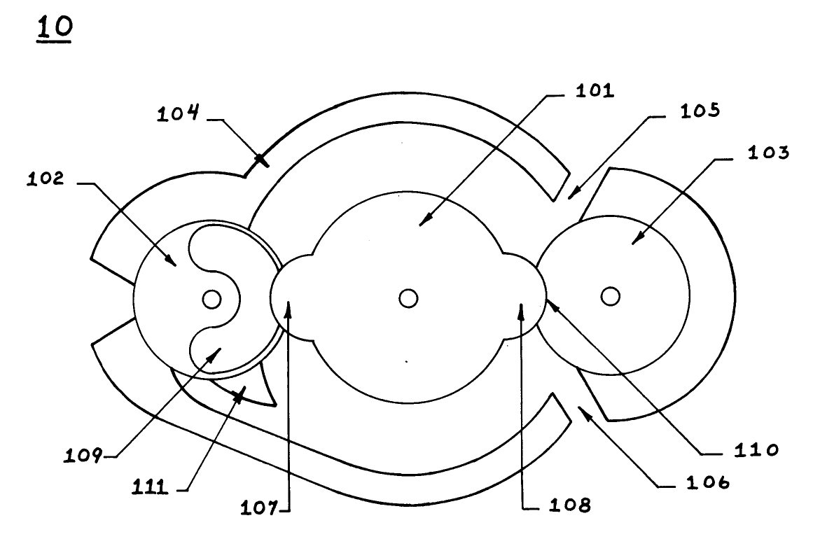

Referring now to FIG. 1, there is shown generally at 10 a rotary piston engine seen to include a main rotor 101, a power rotor 102, and an exhaust rotor 103. Power rotor 102 and exhaust rotor 103 are attached to gears on a one to two ratio with a gear attached to main rotor 101. The housing 104 has inside diameters that have a slip fit to the diameter of power rotor 102 and exhaust rotor 103 and the major diameter of main rotor 101. The major diameter of main rotor 101 is that which includes the length of the rotary pistons 107 and 108. The housing has an intake port 105 and an exhaust port 106. The three rotors are machined in such a manner so as to remain in contact with one another throughout the entire combustion cycle.

In operation, main rotor 101 rotates in a counter clockwise direction, while power rotor 102 and exhaust rotor 103 rotate clockwise. The rotary pistons 107 and 108 of the main rotor 101 alternately engage the walls of the housing 104, the power rotor chamber 109, and the exhaust rotor chamber 110. The housing may include an expansion channel 111 which allows the expansion of the gas to continue throughout the stroke.

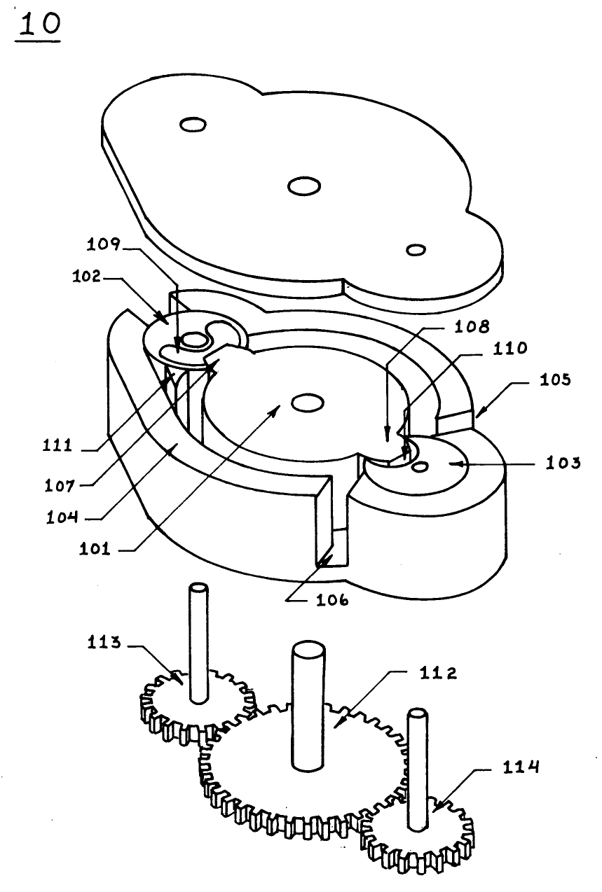

Referring to FIG. 2, in one preferred embodiment, the diameters of power rotor 102 and exhaust rotor 103 and the minor diameter of main rotor 101 are equal to the pitch diameter of their respective gears: main rotor gear 112, power rotor gear 113, and exhaust rotor gear 114. This creates a friction seal. The minor diameter of main rotor 101 is that diameter which does not include the length of the rotary pistons 107 and 108. The pitch diameter of the gears is that which includes half the length of the individual gear teeth on each gear.

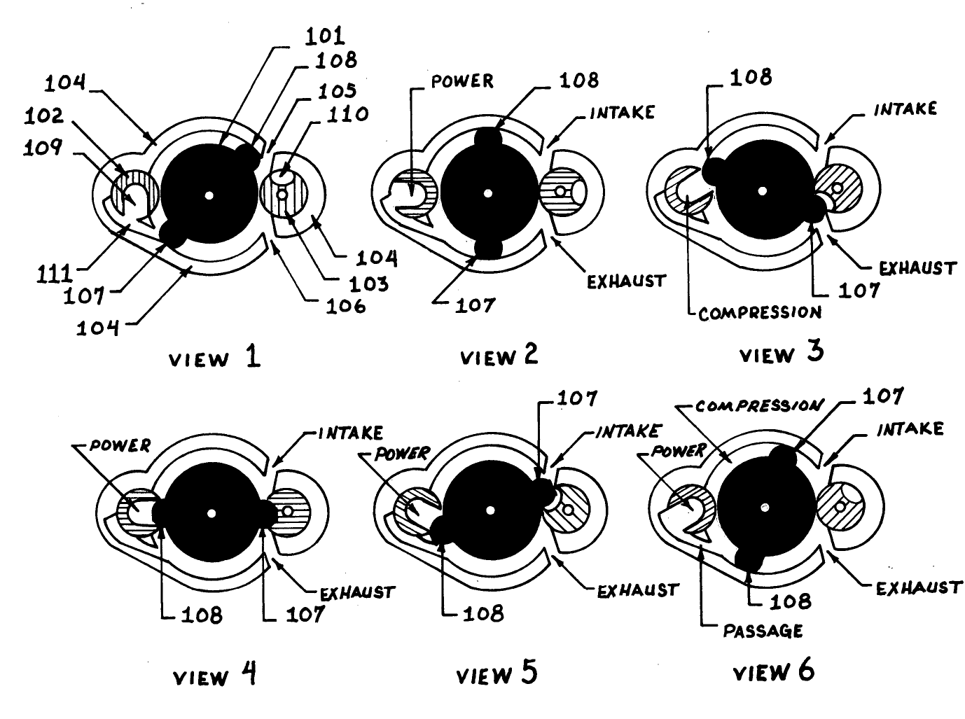

Referring to FIG. 3, in View 1 through 6, gas enters the engine through intake port 105, is compressed between rotary piston 108 and power rotor 102, and is released as exhaust through exhaust port 106. Combustion occurs within power rotor chamber 109 to provide power to the engine. These strokes take place simultaneously within the engine. When rotary piston 108 reaches power rotor 102 in View 3, the compressed fuel mixture is forced into power rotor chamber 109 and is transferred from the front of rotary piston 108 to behind it. This feature allows the rotary piston engine to operate in a true rotary fashion. In View 4, when rotary piston 108 is slightly before dead center, the compressed fuel mixture is ignited, forcing the rotation of main rotor 101. The engine housing 104 may also contain an expansion channel 111 to allow the expansion of gas to continue more effectively throughout the stroke.

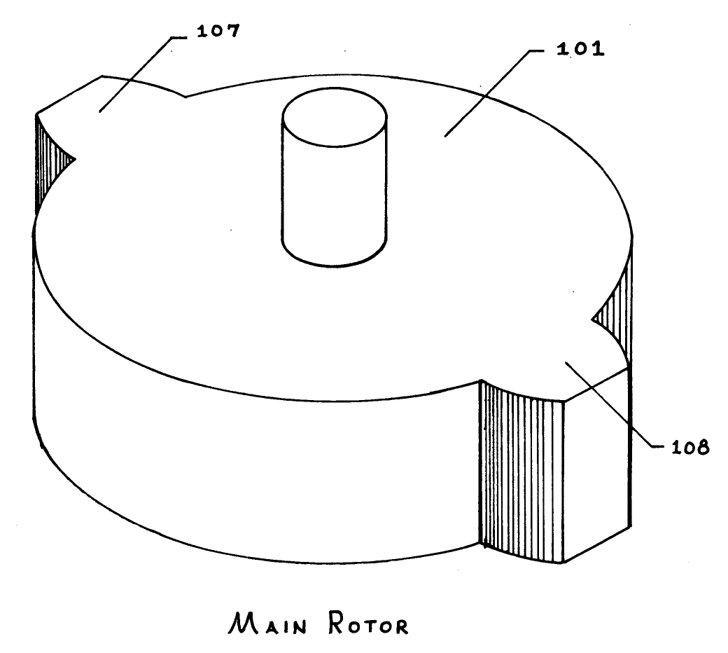

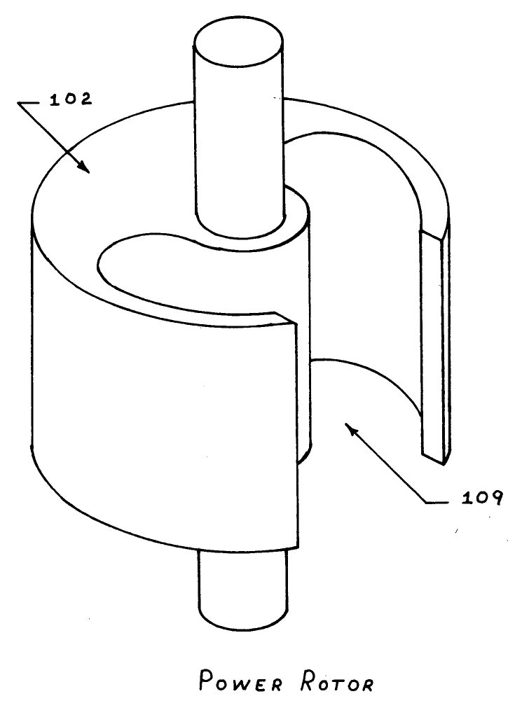

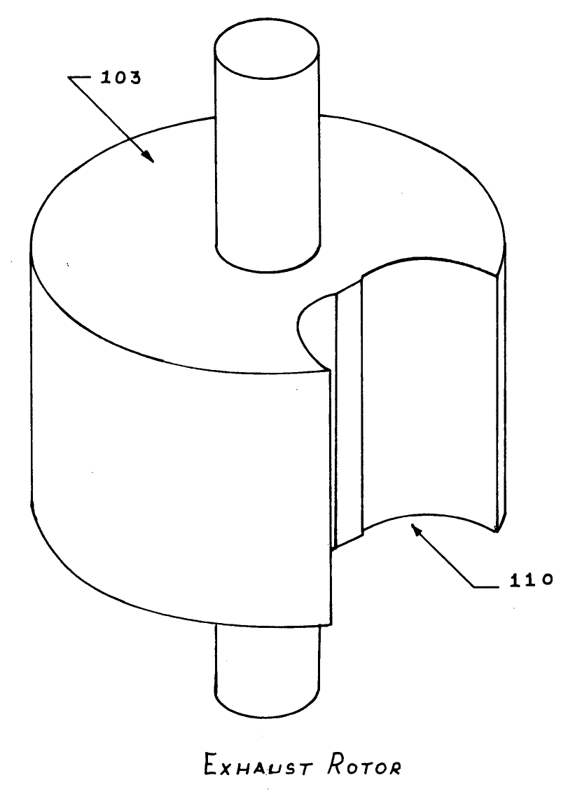

FIG. 4 shows an enlarged view of main rotor 101 and rotary pistons 107 and 108. FIG. 5 shows an enlarged view of power rotor 102 with its power rotor chamber 109. The shape of power rotor chamber 109 allows for the compression and ignition of gas as it is forced into the chamber by rotary piston 107 or 108. The ignition of gas within power rotor chamber 109 creates a force on rotary piston 107 or 108 and causes the rotation of main rotor 101. FIG. 6 shows an enlarged view of exhaust rotor 103 with its exhaust rotor chamber 110. Exhaust rotor chamber 110 is designed to allow the passage of rotary pistons 107 and 108 during the rotation of main rotor 101. Exhaust rotor 103 maintains contact with main rotor 101 at all time to create two distinct chambers which prevent the mixture of exhaust fumes passing through exhaust port 106 with gas entering through intake port 105.

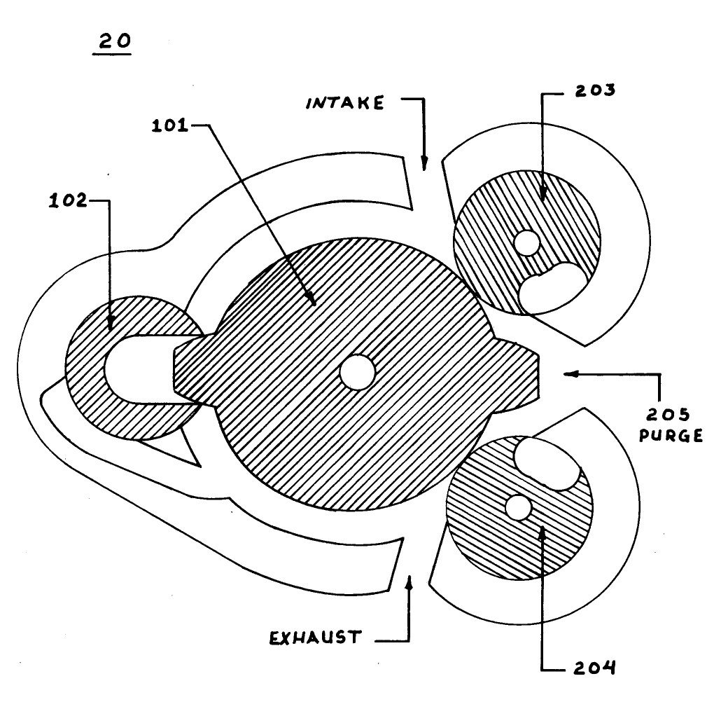

An alternative embodiment of the rotary piston engine 20 is shown in FIG. 7. In this embodiment, there are two separate exhaust rotors 203 and 204. A purge port 205 is included. This embodiment may prevent preignition.

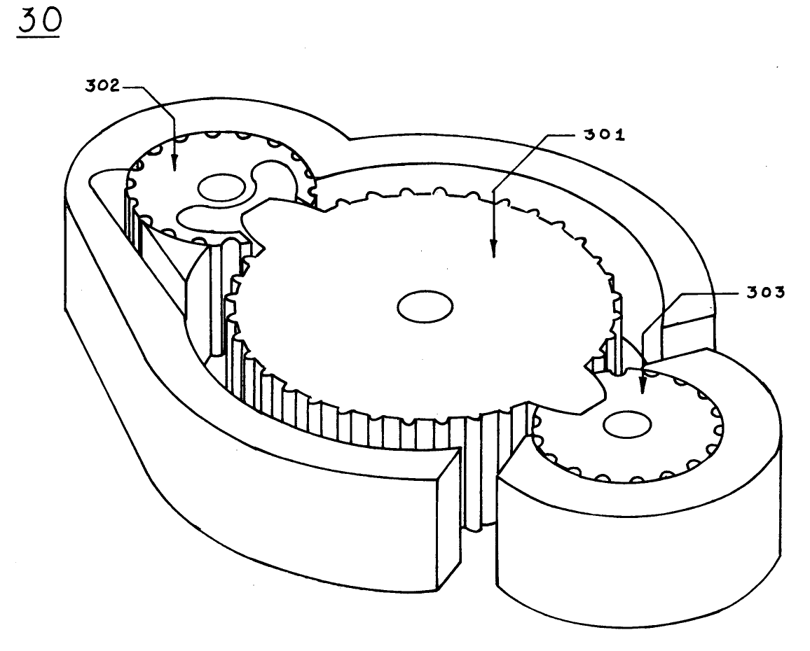

A further alternative embodiment of the rotary piston engine 30 is shown in FIG. 8. In this embodiment, the rotors further comprise gear teeth on their circumferences so that they also serve as gears. Main gear 301 engages power gear 302 and exhaust gear 303. This embodiment eliminates the need for separate gears, such as those shown in FIG. 2. The principles of operation of the rotary piston engine remain the same. The main gear has gear teeth disposed only on its minor circumference and not on the rotary pistons.

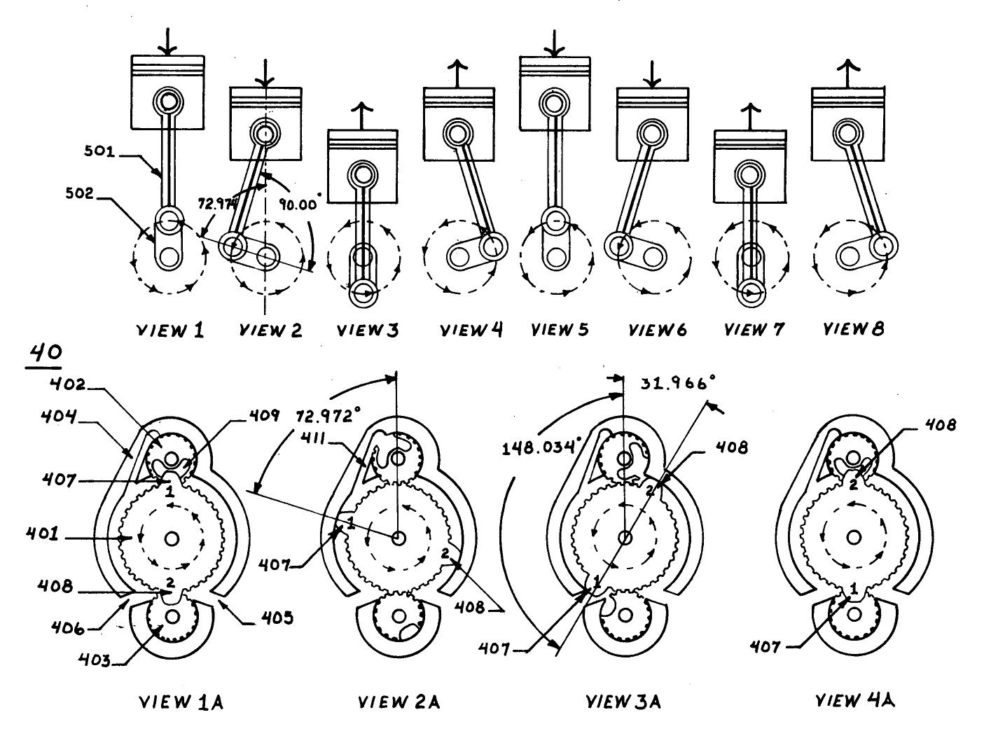

Referring now to FIG. 9, there is shown a comparison of a traditional reciprocating engine with the rotary piston engine 40. Both engines illustrated are four-stroke engines with comparable displacement, with the reciprocating engine having a single cylinder. The rotary piston engine 40 has two pistons, rotary pistons 407 and 408, both using the same combustion chamber in power rotor chamber 409, with all four strokes taking place simultaneously.

Still referring to FIG. 9, the comparison starts with both engines at top dead center at the beginning of the power stroke. At this point, shown in Views 1 and 1a, combustion takes place and each engine is dependent upon momentum to rotate the main shafts enough for expansion to induce rotation. Both engines would be deadlocked were it not for momentum. In the reciprocating engine, peak power transfer takes place when the crank offset 501 and the piston rod 502 are at 90 degrees to one another, as shown in View 2. By contrast, the rotary piston engine 40 has true rotary power through approximately 148 degrees, as shown in View 3a. The expansion channel 411 allows further expansion of the rotating combustion chamber, as shown in View 2a. At that point, as shown in View 3a, momentum is only required for about 32 degrees. This moves rotary piston 407 to bottom dead center and rotary piston 408 to top dead center in preparation for the next power stroke.

By contrast, with continuing reference to FIG. 9, when the reciprocating engine reaches bottom dead center in View 3, momentum takes over, the exhaust valve opens, and the exhaust stroke begins. Exhaust takes place through the next 180 degrees. At top dead center in View 5, the exhaust valve closes, the intake valve opens, and the intake stroke begins. Rotation is still induced by momentum. At bottom dead center in View 7, both valves are closed and the compression stroke begins. The compression stroke is still powered by momentum. At top dead center in View 1, combustion takes place and the cycle starts over.

To sum up, the reciprocating engine requires two revolutions or 720 degrees rotation of the crank shaft to complete all four strokes of the cycle. It depends on momentum for 540 degrees. By contrast, the rotary piston engine requires only one revolution to complete the four strokes of the cycle twice. During that time, the rotary piston engine relies on momentum for only about 64 degrees of the rotation. In the reciprocating engine, 25% of the cycle is devoted to power, while in the rotary piston engine, 82% of the cycle is devoted to power. To provide power 100% of the time, the reciprocating engine requires a minimum of four cylinders. The rotary piston engine requires only two stacked units to provide power 100% of the time, and using two units would produce a 36% overlap of “excess” power.

The rotary piston engine requires high precision fabrication to ensure that the rotors rotate while maintaining a seal between each other and the engine housing. Nevertheless, there are significantly fewer moving parts in the rotary piston engine compared to the reciprocating engine, which makes it more cost-effective to manufacture.

Though the invention has been described with respect to specific preferred embodiments, many variations and modifications will become apparent to those skilled in the art upon reading the present application. It is therefore the intention that the appended claims be interpreted as broadly as possible in view of the prior art to include all such variations and modifications.

What is claimed is:

1. A rotary piston engine that undergoes intake, compression, combustion, and exhaust of gases simultaneously, comprising:
an engine housing;
a main rotor disposed within the engine housing, wherein the main rotor has a plurality of rotary pistons;
a power rotor in contact with a first portion of the main rotor, wherein the power rotor has a power rotor chamber that is configured to engage the rotary pistons of the main rotor and to facilitate the compression and combustion of gases; and
an exhaust rotor in contact with a second portion of the main rotor, wherein the exhaust rotor has an exhaust rotor chamber that is configured to engage the rotary pistons of the main rotor, wherein the main rotor rotates within the engine housing and is rotationally engaged with the power rotor and the exhaust rotor at all times, and wherein the rotary pistons engage the engine housing in a manner that forces the gases to move throughout the engine housing.

2. The rotary piston engine as specified in claim 1 further comprising:
a main rotor gear attached to the main rotor, wherein a minor diameter of the main rotor is equal to a pitch diameter of the main rotor gear;
a power rotor gear attached to the power rotor, wherein a diameter of the power rotor is equal to a pitch diameter of the power rotor gear; and
an exhaust rotor gear attached to the exhaust rotor, wherein a diameter of the exhaust rotor is equal to a pitch diameter of the exhaust rotor gear, wherein the main rotor gear, the power rotor gear, and the exhaust rotor gear are rotationally engaged with a friction seal at each point of contact.

3. The rotary piston engine as specified in claim 1 further comprising an intake port and an exhaust port, wherein the intake port and the exhaust port comprise passages through the engine housing to facilitate the intake and exhaust of gases.

4. The rotary piston engine as specified in claim 1 further comprising an expansion channel disposed within the engine housing configured to provide additional space for the expansion of gases after combustion in the power rotor chamber.

5. The rotary piston engine as specified in claim 1 further comprising a second exhaust rotor in contact with a third portion of the main rotor, wherein the second exhaust rotor has a second exhaust rotor chamber that is configured to engage the rotary pistons of the main rotor.

6. The rotary piston engine as specified in claim 1 wherein the main rotor further comprises gear teeth disposed on its minor circumference to produce a main gear; the power rotor further comprises gear teeth disposed on its circumference to produce a power gear; and the exhaust rotor further comprises gear teeth on its circumference to produce an exhaust gear, wherein the main gear, the power gear, and the exhaust gear are rotationally engaged with a friction seal at each point of contact.
